(19) United States
(12) Patent Application Publication
(10) Pub. No.: US 2009/0067106 A1
(43) Pub. Date: Mar. 12, 2009

(54) STATIC ELECTRICITY DISCHARGE CIRCUIT

(75) Inventor: Jang Hoo Kim, Seoul (KR)

Correspondence Address: BAKER & MCKENZIE LLP;PATENT DEPARTMENT, 2001 ROSS AVENUE, SUITE 2300, DALLAS, TX, 75201, US

(73) Assignee: Hynix Semiconductor, Inc., Ichon (KR)

(21) Appl. No.: 12/208,195

(22) Filed: Sep. 10, 2008

(30) Foreign Application Priority Data
Sep. 10, 2007 (KR) 10-2007-0091758

(51) Int. Cl. H02H 9/04

(52) U.S. Cl. 361/56

(57) ABSTRACT

A static electricity discharge circuit applied to a highly integrated semiconductor circuit includes a discharge unit connected with the input/output pad by a node and providing, in parallel to the node, a first discharge path connected with a power voltage line and a second discharge path connected with a ground voltage line, an electrostatic detection unit including a diode chain connected to the node and detecting a detection voltage corresponding to static electricity inputted to the node, and a clamp unit switching the discharge path between the power voltage line and the ground voltage line by the detection voltage of the electrostatic detection unit.

### CROSS-REFERENCE TO RELATED APPLICATIONS

The present application claims priority under 35 U.S.C. 119(a) to Korean patent application number 10-2007-0091758 filed in the Korean Intellectual Property Office on Sep. 10, 2007, which is incorporated herein by reference in its entirety as if set forth in full.

### BACKGROUND

1. Technical Field

The embodiments described herein relate to a static electricity discharge circuit, and more precisely, to a static electricity discharge circuit used to prevent defect in a semiconductor device due to a static electricity.

2. Related Art

In general, semiconductor devices are sensitive to the static electricity. When a high voltage is applied to an integrated circuit due to electrostatic discharge (hereinafter, referred to as ESD), thin insulation layers, channels and so on within the integrated circuit can be damaged by the high voltage and the chip becomes unable to operate normal. Therefore, in order to protect the integrated circuit from ESD, a conventional semiconductor integrated circuit has a built-in static electricity discharge circuit placed at an input/output pad.

Such a static electricity discharge circuit is connected in parallel between an input/output pad or a power pad and ground within the integrated circuit of the chip to provide a discharge path. Therefore, the static electricity discharge circuit can discharge the static electricity and prevent the static electricity from damaging the integrated circuit.

Recently, as the degree of integration increases, the size of semiconductor devices (e.g. MOS transistor) decreases, which can make the device more sensitive to static electricity.

Conventional static electricity discharge circuits are shown in FIGS. 1 and 2.

A static electricity discharge circuit 100 as illustrated in FIG. 1 includes an ESD protection unit 130 and a grounded gate NMOS transistor (herein after, referred to as GGNMOS transistor) disposed in parallel between a power voltage line 150 and a ground voltage line 160. The ESD protection unit 130 is connected between the power voltage line 150 and the ground voltage line 160 with respect to a node a between an input/output pad 110 and an internal circuit 120.

The power voltage line 150 is connected with the ESD protection unit 130 through a node (b1) and the GGNMOS transistor 140 through a node (b2). The ground voltage line 160 is connected with the ESD protection unit 130 through a node (c1) and the GGNMOS transistor 140 through a node (c2).

The ESD protection unit 130 includes a diode 131 connected between the power voltage line 150 and the input/output pad 110 and a diode 132 connected between the input/output pad 110 and the ground voltage line 160.

When positive (+) static electricity is input into the static electricity discharge circuit of FIG. 1, the positive (+) static electricity is discharged to the ground voltage line 160 through the path of node (a)→node (b1)→node b2→node (c2).

The positive (+) static electricity causes the GGNMOS transistor to turn on and discharge the positive (+) static electricity to the ground voltage line 160 through node (c2); however, the discharge circuit 100 has relatively long rising time, which delays the turn on of the GGNMOS transistor 140. Therefore, the internal circuit 120 may be influenced by the static electricity, due to the delay in turning on the GGNMOS transistor.

In order to solve the problem of the response speed in the static electricity discharge circuit 100 in FIG. 1, there has been suggested a RC trigger type static electricity discharge circuit 200 in FIG. 2.

The static electricity discharge circuit 200 in FIG. 2 is disposed between an input/output pad 210 and an internal circuit 220, and includes an ESD protection unit 230 that provides a discharge path or static electricity applied from the input/output pad 210, a trigger unit 240 that generates a trigger voltage related to the static electricity transferred from the ESD protection unit 230, and a clamping unit 250 that is activated by the trigger voltage. The ESD protection unit 230, the trigger unit 240, and the clamping unit 250 are connected in parallel between a power voltage line 260 and a ground voltage line 270.

The power voltage line 260 is connected with the ESD protection unit 230 through a node (e1), the trigger unit 240 through a node (e2), and the clamping unit 250 through a node (e3). The ground voltage line 270 is connected with the ESD protection unit 230 through a node (f1), the trigger unit 240 through a node (f2), and the clamping unit 250 through a node (f3).

The ESD protection unit 230 includes a diode 231 connected between the power voltage line 260 and the input/output pad 210 and a diode 232 connected between the input/output pad 210 and the ground voltage line 270.

The trigger unit is provided with a resistance component 241 and a capacitor 242, and the clamping unit 250 is provided with a gate coupled NMOS transistor (hereinafter, referred to as GCNMOS transistor) 152 in which gate and drain thereof are coupled.

In the static electricity discharge circuit 200 in FIG. 2, a positive (+) static electricity input through the input/output pad 210 is transferred to the nodes (e2) and (e3) through positively biased diode 231, and the static electricity transferred to the node (e3) is discharged to the ground voltage line 270 through the GCNMOS transistor 251 when the GCNMOS transistor 251 is turned on by the trigger voltage generated by the trigger unit 240.

The static electricity discharge circuit 200 has a response speed faster than that of the static electricity discharge circuit 100 in FIG. 1 since it discharges the static electricity as the GCNMOS transistor 251 is turned on by the trigger voltage generated by the trigger unit 240.

In other words, since the ESD path of the static electricity discharge circuit 200 in FIG. 2 is turned on by lower voltage than in the static electricity discharge circuit 100 in FIG. 1, the static electricity discharge circuit 200 in FIG. 2 can better protect the internal circuit 220.

Sufficient current should be supplied to the gate of the GCNMOS transistor 251 to turn on the GCNMOS transistor 251. This requires an increase in the area of the capacitor 242 to achieve a resultant increase in capacitance, which is needed to supply sufficient current. The increased area prevents higher integration of the semiconductor integrated circuit.

### SUMMARY

A static electricity discharge circuit in which an electrostatic discharge path is turned on by a low trigger voltage is described herein. A static electricity discharge circuit that has a fast response characteristic to static electricity is also described herein, as is a static electricity discharge circuit that can perform electrostatic discharge with small area.

According to one aspect, there is provided a static electricity discharge circuit that discharges static electricity input from an input/output pad, which include: a discharge unit connected with the input/output pad by a node and providing, in parallel to the node, a first discharge path connected with a power voltage line and a second discharge path connected with a ground voltage line, an electrostatic detection unit including a diode chain connected to the node and detecting a detection voltage corresponding to static electricity inputted to the node, and a clamp unit switching the discharge path between the power voltage line and the ground voltage line by the detection voltage of the electrostatic detection unit.

According to another aspect, there is provided a static electricity discharge circuit that discharges static electricity inputted into a node between an input/output pad and an internal circuit, which include: a discharge unit including at least one of a first discharge unit that provides a first discharge path between the node and a power voltage line and a second discharge path between the node and a ground voltage line, a diode chain connected with the node, wherein the diode chain has a turn-on voltage of higher level than that of a normal input signal of the node and detects a detection voltage corresponding to static electricity inputted to the node, and a MOS transistor connected between the power voltage line and the ground voltage line and switching the discharge path between the power voltage line and the ground voltage line by apply of the detection voltage of the diode chain to the gate of MOS transistor.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a circuit diagram showing a conventional static electricity discharge circuit.

FIG. 2 is a circuit diagram showing a conventional RC trigger type static electricity discharge circuit.

FIG. 3 is a circuit diagram showing a static electricity discharge circuit according to one embodiment.

FIG. 4 is a graph comparing trigger voltages for the circuit of FIG. 3 and for the circuits of FIG. 1 and FIG. 2.conventional art.

FIG. 5 is a graph illustrating current and leakage current in static electricity discharge circuit of FIG. 3.

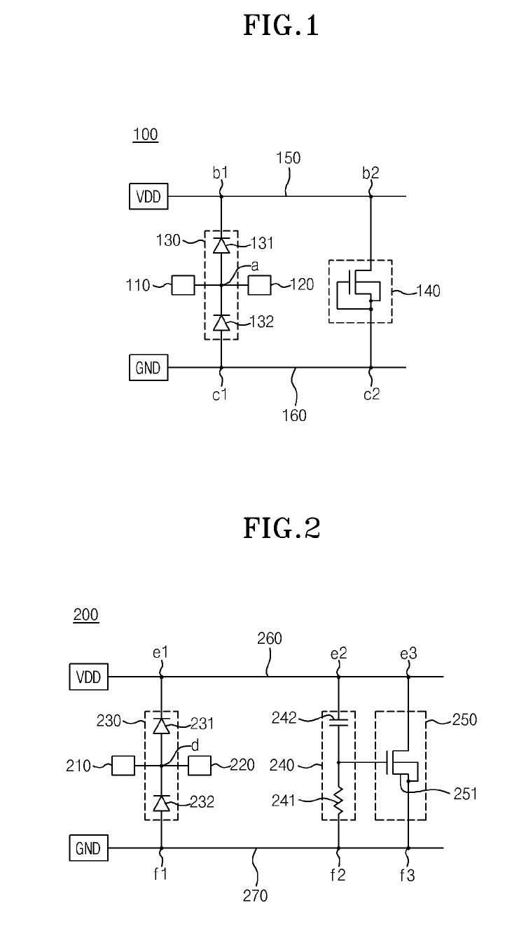

### DETAILED DESCRIPTION

A static electricity discharge circuit according to the embodiments described herein can operate only when static electricity is applied without influence by an input signal, raise triggering speed, and reduce the circuit area by using a chain diode instead of a capacitor.

As such, a static electricity discharge circuit according to the embodiments described herein can be applied to integrated circuit devices such as highly integrate semiconductor memory devices, micro processors, micro-electromechanical systems, opto-electronic devices and LCD driver ICs.

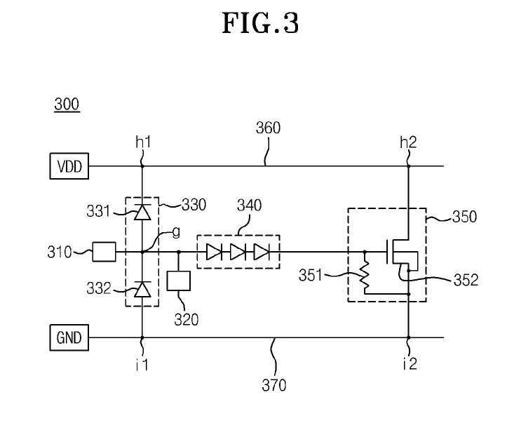

FIG. 3 is a diagram illustrating a static electricity discharge circuit 300 according to one embodiment. As can be seen, circuit 300 can be connected between an input/output pad 310 that can be configured to send/receive external signals and an internal circuit 320 that can be configured to receive signals input through the input/output pad 310, and provide a discharge path between a power voltage line 360 and a ground voltage line 370 to discharge static electricity.

Specifically, the static electricity discharge circuit 300 can include a discharge unit 330 that can be configured to provide the discharge path for the static electricity applied from the input/output pad 310, an electrostatic detection unit 340 that can comprise a diode chain and that can be configured to generate a detection voltage that corresponds to the static electricity applied from the input/output pad 310, and a clamp unit 350 that can be configured to switch the discharge path between the power voltage line 360 and the ground voltage line 370 under control of the detection voltage from the electrostatic detection unit 340.

The discharge unit 330 can include a diode 331 connected between the power voltage line 360 and the input/output pad 310 and a diode 332 connected between the input/output pad 310 and the ground voltage line 370.

The electrostatic detection unit 340 can be connected to a node (g) between the input/output pad 310 and the clamp unit 350, and the number of the diodes constituting the diode chain should be determined so as to have a turn-on voltage higher than the voltage of a normal input signal applied to the internal circuit 320.

The clamp unit 350 can be provided with a GCNMOS transistor 352 in which a gate and a bulk thereof are coupled and a resistance component 351 that applies a bias voltage to the GCNMOS transistor 352.

The power voltage line 360 can be connected with the discharge unit 330 through a node (h1) and the clamp unit 350 through a node (h2). Also, the ground voltage line 370 can be connected with the discharge unit 330 through a node (i1) and the clamp unit 350 through a node (i2).

In the static electricity discharge circuit 300, operation properties vary with the voltage level and transfer path of the static electricity applied from the outside.

An operation of discharging positive (+) static electricity to the ground voltage line 370 when the positive (+) static electricity is applied to the static electricity discharge circuit 300 will now be described in detail.

The positive (+) static electricity input through the input/output pad 310 turns on the electrostatic detection unit 340. But if the positive static electricity has an insufficient voltage level, then the diode chain of detection unite 340 is not turned on.

The electrostatic detection unit 340 can preferably be constructed so as to have a turn-on voltage larger than the voltage of the normal input signal. This way, the static electricity discharge circuit 300 is not influenced by the input signal and turns on, only when a static electricity having a voltage larger than the voltage of the normal input signal is applied to the detection unit 340.

The electrostatic detection unit 340, therefore, can be a device that biases the voltage due to the static electricity to the GCNMOS transistor 352 using a diode chain, instead of the capacitor 242 of the conventional RC trigger type static electricity discharge circuit 200 as illustrated in FIG. 2. Moreover, the diode chain will occupy a smaller area as compared to the capacitor 242. The triggering speed of unit 340 should also be relatively faster than that of the trigger circuit using the capacitor 242. In other words, since the current flowing in the resistance device 351 is larger than the current flowing in, e.g., the resistance device 241, the static electricity discharge circuit 300 can realize a relatively faster triggering speed than in circuits using the RC trigger circuit of FIG. 2.

The positive (+) static electricity flowing to the first diode 331 through the input/output pad 310 is transferred from the node (g) to the node (h1) through the positively biased first diode 331, and then transferred to the node (h2) through the power voltage line 360. After that, the static electricity transferred to the node (h2) is transferred to the node (i2) through the clamp unit 350 and finally discharged to the ground voltage line 370.

In other words, the positive (+) static electricity input through the input/output pad 310 can be discharged through the path of nodes (g)→(h1) >(h2)→(i2).

As described above, since a diode chain is used, e.g., instead of a capacitor 242, of the current flowing in the static electricity detection unit 340 and the clamp unit 350 ensures faster triggering speed of the clamp unit 350 than the current flowing, e.g., in the trigger unit 240 and the clamp unit 250 of the conventional RC trigger power clamp circuit 200 illustrated in FIG. 20. Therefore, the internal circuit 320 can be protected from static electricity faster due to the faster response speed.

Also, since the diode chain is used instead of the capacitor, the area in a semiconductor chip occupied by the static electricity discharge circuit 300 is reduced. Therefore, it is more suitable to highly integrated circuit.

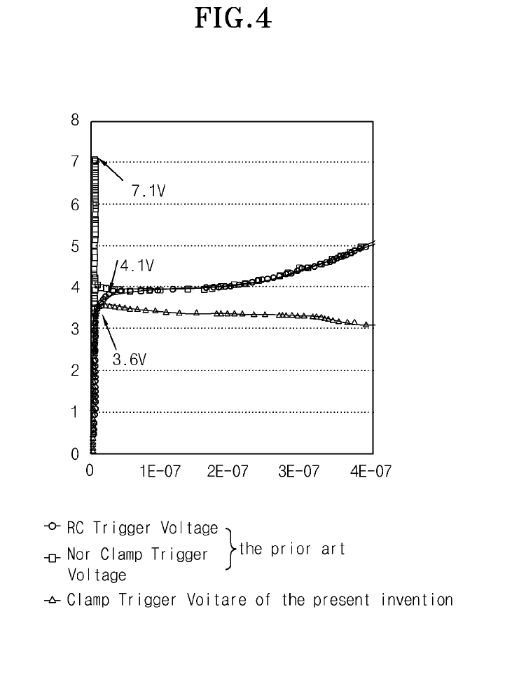

FIG. 4 is a graph comparing trigger voltages of conventional static electricity discharge circuit 100, conventional RC trigger type static electricity discharge circuit 200, and the static electricity discharge circuit 300. It can be appreciated that the static electricity discharge circuit 300 has the lowest voltage and shows the fastest triggering characteristic.

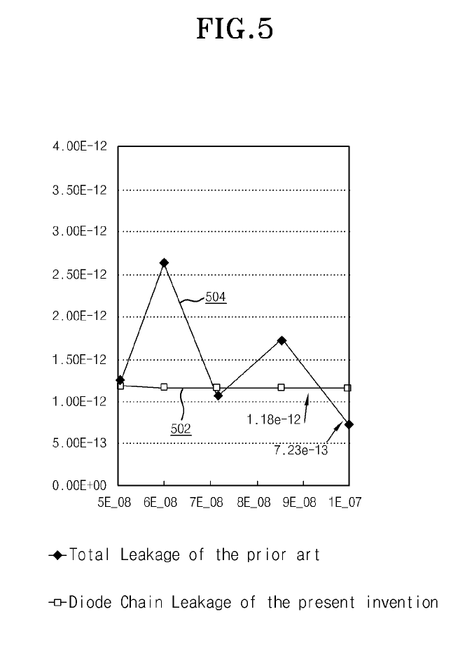

FIG. 5 is a graph illustrating leakage current flowing through the electrostatic detection unit 340 when the static electricity is not applied to the static electricity discharge circuit 300. This leakage current is illustrated by plot 502. It can be appreciated that the leakage current does not have an influence on the suggested static electricity discharge circuit 300 since the leakage current flowing through the electrostatic detection unit 340 when the static electricity is not applied to the static electricity discharge circuit 300 is low current of 0.1 pA. This leakage current (plot 502) can be compared to that of a conventional circuit as illustrated in plot 504.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A static electricity discharge circuit that discharges static electricity input from an input/output pad, comprising:
a discharge unit connected with the input/output pad at a node and providing, in parallel to the node, a first discharge path connected with a power voltage line and a second discharge path connected with a ground voltage line;
an electrostatic detection unit including a diode chain connected to the node and configured to generate a detection voltage corresponding to static electricity input to the node by the diode chain; and
a clamp unit configured to enable a discharge path between the power voltage line and the ground voltage line based on the detection voltage of the electrostatic detection unit.

2. The static electricity discharge circuit as set forth in claim 1, wherein the electrostatic detection unit includes a plurality of serially connected diodes configured to have a turn-on voltage, the turn-on voltage having a higher level than that of a normal input signal to the input/output pad.

3. The static electricity discharge circuit as set forth in claim 1, wherein the node is connected with an internal circuit.

4. The static electricity discharge circuit as set forth in claim 1, wherein the clamp unit includes a Gate Coupled NMOS transistor connected between the power voltage line and the ground voltage line and a resistance component connected between a gate of the GCNMOS transistor and the ground voltage line.

5. The static electricity discharge circuit as set forth in claim 4, wherein the resistance component includes a substrate resistor of the GCNMOS transistor.

6. The static electricity discharge circuit as set forth in claim 1, wherein the static electricity discharge circuit is included in a highly integrate semiconductor memory device, micro processor, micro-electromechanical system, opto-electronic device, or LCD driver integrated circuit.

7. A static electricity discharge circuit that discharges static electricity input into a node between an input/output pad and an internal circuit, comprising:
a discharge unit including at least one of a first discharge unit that provides a first discharge path between the node and a power voltage line and a second discharge path between the node and a ground voltage line;
a diode chain connected with the node, wherein the diode chain has a turn-on voltage of higher level than that of a normal input signal of the node and that is configured to generate a detection voltage corresponding to static electricity input to the node; and
a MOS transistor connected between the power voltage line and the ground voltage line and configured to enable a discharge path between the power voltage line and the ground voltage line in response to the detection voltage of the diode chain, the MOS transistor comprising a gate configured to receive the detection voltage.

8. The static electricity discharge circuit as set forth in claim 7, wherein the MOS transistor is a GCNMOS transistor and a resistance component is connected between a gate of the GCNMOS transistor and the ground voltage line.

9. The static electricity discharge circuit as set forth in claim 8, wherein the resistance component includes a substrate resistor of the GCNMOS transistor.

10. The static electricity discharge circuit as set forth in claim 7, wherein the static electricity discharge circuit is included in a highly integrate semiconductor memory device, micro processor, micro-electromechanical system, opto-electronic device, or LCD driver integrated circuit.
